(19) United States
(12) Patent Application Publication
(10) Pub. No.: US 2008/0187620 A1
(43) Pub. Date: Aug. 7, 2008

(54) Natural Antioxidative Additive for Feed and Products Used for Humans

(75) Inventors: Beatrice Konstanze Klinzing Nielsen, Hvidovre (DK); Troels Elgaard, Bronby Strand (DK)

Correspondence Address: Dorsey & Whitney LLP;US Bank Center, 1420 Fifth Avenue, Suite 3400, Seattle, WA, 98101-4010, US

(73) Assignee: NOR-FEED A/S, Hvidovre (DK)

(21) Appl. No.: 11/792,634

(22) PCT Filed: Dec. 8, 2005
(86) PCT No.: PCT/DK05/00776

§ 371 Date: Mar. 12, 2008

(30) Foreign Application Priority Data
Dec. 10, 2004 (DK) BA200400319

(51) Int. Cl. A23K 1/16; C11B 5/00; A23K 3/00

(52) U.S. Cl. 426/2; 426/542

(57) ABSTRACT

Natural intestine-functional and preservative additive with antioxidative characteristics used as addition in feed for animals and a natural additive with antioxidative characteristics for use as addition in oxygen sensitive products including food products, feed products, cosmetics, pharmaceutics and other oxidation sensitive products for human or animal use. The additive is cost-efficient and can be derived from a plant material originating from olive (Olea europaea L.). The additive is effective as addition to feed, when breeding and producing livestock, as a substitute for traditional growth promoters, which are now being phased out, and as a substitute for synthetic antioxidants, which have shown carcinogenic characteristics.

### TECHNICAL FIELD

The present invention relates to a natural or natural identical antioxidative additive; a natural intestine-functional antioxidative feed additive; a natural preservative antioxidative additive; an oxidation sensitive product selected among food products, feed products, cosmetics, pharmaceutics and other oxidation sensitive products for human or animal use preserved with the additive; a method by producing livestock; a method for the preservation of an oxidation sensitive product selected among food products, feed products, cosmetics, pharmaceutics and other oxidation sensitive products for human or animal use as well as the use of the additive.

### BACKGROUND ART

The use of antibiotic or chemotherapeutic substances, referred to as ‘growth promoters’, in the production of livestock is well known. In recent years attention has increasingly focused on problems related to the widespread use of antibiotics or chemotherapeutics as growth promoters. More and more pathogenic micro-organisms are able to develop resistance to the antibiotics which thus become less effective. There is a risk that residues of antibiotics are left in animal products consumed by humans, whereby microorganisms that cause disease can become resistant. Also, there is a risk of consuming antibiotic-resistant micro-organisms through animal products. Antibiotics may be rediscovered in the ground water and in streams. Finally there is a risk that humans, who produce and use feed containing antibiotics, will have antibiotics-resistant bacteria in their bodies.

In consequence of the above a continued use of antibiotics as growth promoters is, among others, expected to increase the risk of epidemic outbreaks among animals and/or humans, which cannot be treated by antibiotics. A considerable number of humans have already developed allergy towards certain antibiotics. Furthermore, one of the so far used chemotherapeutic growth promoters has shown to be causing cancer.

The result of this has already been a complete stop of the use of classical growth promoters in swine production in various countries, including Denmark and Sweden, and will be banned within the EU by the end of 2005.

As a consequence of the relations mentioned above, and to ensure the economy and sustainability in livestock farming, new alternative methods are sought to ensure the livestock's growth conditions free of both disease and use of antibiotics.

Such drugs can advantageously be based on natural or nature identical active substances. To ensure the acceptance of these new additives by the farmer, as well as the feed industry, they should also have the same or even better effect on the animals' growth and feed utilization as the classical growth promoters.

It is well known that many plants contain various functional and/or antibacterial substances, such as saponins, flavonoids, tannins, hydroxycymens and terpenes, and it is also known to exploit such active substances from plant materials in medicine. A considerable part of the positive characteristics of these active substances are caused by their antioxidative characteristics. Antioxidants protect the cells against degradation and harmful substances, reduce the risk of infection, and have a special effect in intensive production systems and stress situations.

Antioxidants have not only an effect after being absorbed in animals and humans but likewise have a protective effect on feed—and foodstuffs, medicine, the raw materials contained in these and on other products used for humans—eg. cosmetics. The health promoting unsaturated fatty acids are quickly decomposed by heat, moisture, minerals etc. and shall hence be protected against degradation, which today is primarily done by addition of synthetic antioxidants such as BHT, BHA and Ethoxyquin. Synthetic antioxidants have however in some trials shown an increased cancer-causing effect and natural alternatives are therefore a necessity. Other typical substances that demands protection against degradation include carotenoides such as beta-caroten, astaxanthin, capsanthin, lutein, lycopene and zeaxanthin. Typical oils demanding protection against rancidity include fish oil, linseed oil and evening primrose oil.

Similarly it has been suggested to use such natural substances as daily supplements for both animals and humans. The claimed effects of such active plant components are, however, in many cases not adequately well-documented, and many of the components appear only in small amounts in the concerned plants, just as they are mostly too costly and/or too difficult to access for a preventive daily use as feed additive.

It is well known that the olives have a number of health promoting effects, such as lower risk of developing cardiovascular diseases and cancer, which partly has been dedicated the high content of antioxidants of the olives. Among the isolated antioxidants from olive oil are phenol components like simple phenols (hydroxytyrosol ((3.4-dihydroxyphenyl)ethanol), tyrosol (p-hydroxyphenylethanol)), secoiridoids (oleuropein) and lignans (pinoresinol) and other polyphenols (Owen et al., 2000: Olive-oil consumption and health: the possible role of antioxidants. The Lancet Oncology 1, 107-112). These active substances have shown biological activity, among these inhibition of cell growth of cancer cells and antiviral and antioxidative activity (eg. inhibition of oxidation of low-density lipoproteins (LDL) and inhibition of oxidative stress). The antioxidative activity from the active substances found in olive is far more effective than a synthetic form of vitamin E (Owen et al., 2000: Olive-oil consumption and health: the possible role of antioxidants. The Lancet Oncology 1, 107-112). There has been found in vitro anti-microbial activity in olive leaves (Markin et al. 2003. In vitro anti-microbial activity of olive leaves. Mycoses 46 (3-4): 132-136) and antifungal activity (Del Rio et al. 2003: Enhancement of phenolic compounds in olive plants and their influence on resistance against Phytophthora sp. Food Chemistry 83 (1): 75-78).

A high level of antioxidants in the feed can also result in an improved product quality in milk and meat for instance, while it is well known that antioxidants in the feed (such as eg. from oregano, ascorbic acid and alpha-tocopherol) has a positive effect on the quality of the meat (Stagsted et al. 2003. Ascorbic acid, alpha-tocopherol, and oregano supplements reduce stress-induced deterioration of chicken meat quality. Poultry Science 82 (8), 1343-1351), such as better stability of fat, lower level of drip loss and an improved meat colour. The stability of fatty acids in the product has a critical significance for the product's taste and shelf-life. Drip loss and meat colour are critical elements in the consumers' perception of meat products.

Various patents describe methods for the extraction of antioxidants from olive-based material US 2002/0004077 A1 (Cuomo et al). WO 03/086442 discloses naturally occuring plant compounds, extracts and derivatives, among these oleuropein, for protection of health promoting products for humans. This and other applications, which include parts of olive as antioxidant for products in the human sector are based on costly extracts from an olive-based material. A cost-effective additive with antioxidative characteristics is therefore needed in the human sector.

Equally there is a need for cost-effective additives for livestock, which has a protective effect on the feed, a health promoting effect for the animal along with an improving effect on the product quality.

It has now been found that it is possible to obtain a desirable cost-effective antioxidative product from an olive-based material which product is usable as a preservative and/or intestine-functional additive which protects oxygen sensitive products and promotes both animal health and quality of animal products and products used in the human sector when added to conventional animal feed or to food products, cosmetics, pharmaceutics and other oxidation sensitive products for human or animal use.

The prior art does not describe olive based cost-effective additives with the above mentioned properties.

### DISCLOSURE OF INVENTION

The present invention relates to a natural or natural identical antioxidative additive which further to optional conventional carriers, adjuvants and/or additives as an active antioxidative principle includes an active component containing active substances derived from plant material from olive (Olea europaea L.).

The inventive additive includes a cost-efficient active antioxidative component derived from relevant parts of the olive tree such as the leaves and/or the fruits which parts often can be obtained as by-product or waste product by conventional production of olive oil.

Trials has demonstrated increased weight gain of piglets from weaning receiving the additive providing 400 ppm dried ground olive leaves or 15 ppm dried extract of olive leaves in conventional piglet feed. Thus only small amounts obtainable from abundant resources are needed. The same apply to the use as preservative for oxygen sensitive products for which an effective level of 20-5000 ppm is contemplated.

Due to its antioxidative action the inventive additive is useful both as a preservative for oxygen sensitive materials and as an intestine active feed additive. When used as a feed additive it improves weight gain and feed conversion in production animals and it has positive effects on the health of both production animals and pets. Furthermore, the inventive additive improves the quality of animal products such as milk, eggs and meat.

The invention also relates to an oxidation sensitive product selected among food products, feed products, cosmetics, pharmaceutics and other oxidation sensitive products for human or animal use including the inventive additive with conventional ingredients of such product.

Furthermore the invention relates to a method by producing livestock whereby the animals are fed a feed mixture including the additive or whereby the additive is added to the drinking water of the animals.

The invention also provides a method for the preservation of an oxidation sensitive product selected among food products, feed products, cosmetics, pharmaceutics and other oxidation sensitive products for human or animal use by adding the additive to the oxidation sensitive product.

Finally the invention relates to the use of the additive for the preservation of food, feed, cosmetics, pharmaceutics and other oxidation sensitive products for human or animal use.

In addition the invention comprises a feed mix for domestic animals containing the additive combined with a conventional feed, as well as an instruction for production of domestic animals when the animals are fed the feed mix.

The invention furthermore concerns a natural additive with antioxidative characteristics for use as addition in feed containing a large share of for instance fatty acids and carotenoids along with corresponding products used for humans and containing natural and/or nature identical active substances including as an active constituents one component, which contains an antioxidative active substance and which can be derived from a plant material originating from olive and added possible conventional carriers and technical additives.

The additive is based on by-products that presently have no other practical use, which lowers the price of the active constituents and makes the product surprisingly more cost efficient.

The extent of applicability of the invention appears from the following detailed description. It should, however, be understood that the detailed description and the specific examples are merely included to illustrate the preferred embodiments, and that various alterations and modifications within the scope of protection will be obvious to persons skilled in the art on the basis of the detailed description.

### DETAILED DESCRIPTION OF THE INVENTION

According to the invention the additive is obtainable on basis of a by-product from the production of olive oil or on basis of olive leaves. When producing olive oil, a by-product referred to as “pulp”, and waste water emerge. These products have a high content of antioxidants, which is also the case with leaves from the olive tree that is not exploited on a large scale.

Olive is the fruit of the olive tree (Olea europaea L). The production of olive oil is carried out by washing the olive fruits, after which they are crushed in a hammer mill. The obtained “pomace”, a mixture of stone and olive pericarp (the flesh itself), is homogenized and moved to platens, where the oil is squeezed out. The water is then separated from the clear oil. More oil fractions can be derived by squeezing the “pomace” repeatedly.

By exploitation of the waste water it is possible to dry, the obtained liquid product, down to a water content level of 8-15% at the highest, usually to a maximum water content of 10% water or it can be preserved by adding for instance 0 to 10 weight % NaCI or another salt, and thereafter restore it for later drying. To further secure the keeping qualities it is beneficial to add 0 to 5% of an acid acceptable for feed, such as citric acid, tartaric acid or lactic acid or a mixture of these, of which addition at the same time has a positive influence on the product's effect. In addition it can be beneficial to add for instance sodium benzoate, potassium sorbate, sorbic acid or calcium propionate as a preservative.

To the extent deemed necessary, the waste water, the residual products from the pressing and the dried and ground olive leaves can be concentrated further by removing some of the water left in the products. This can be done by filtration, extraction, centrifugation or other conventional methods.

Extracts can be produced by extraction of the relevant plant material with water, alcohol or a combination thereof, preferably with water or a water/alcohol mixture. The extracts can be used in the existing liquid form, or in powder form manufactured by drying, such as spray drying, and/or by absorption and/or by adsorption on an expedient carrier agent.

In principle the plant material can be derived from any of the relevant parts of the olive plant, especially the leaves and/or fruits, provided such plant material contains antioxidative substances in a sufficient amount. Examples are products derived as by products from the leaves and fruits of the olive tree in connection with olive oil production.

The invention does therefore concern, a product based on dried and ground olive leaves or an extract hereof, the pomace from the production of olive oil or a concentrated liquid, which originates from the waste water of the olive oil production, including any combination thereof.

In preferred embodiments the active component of the inventive additive may be in the form of a liquid, a dried, such as spray dried, powder or a ground product, or any combination thereof.

Olive leaves and by-products from the production of olive oil contain a series of interesting active substances. Among the most interesting are primarily polyphenols with antioxidative properties. The additive has, according to the invention among other the following beneficial effects:

1) Protection against degradation of oxidation sensitive products and products with a high content of carotenoids for both the human sector and animals by its antioxidative effect.

2) Used as a feed additive, an antioxidative effect in the animal by
protection against degradation of cells
reducing the usage of other antioxidants such as vitamin E and selenium
protection against heat stress.

3) Improvement of productivity and health status in animals by
having antimicrobial and antiviral characteristics
improving feed conversion
improving the utilization of nutrients
improving health status by protecting the epithelial cells in the gastrointestinal tract
stimulating the animals' immune system and thereby protect against stress related diseases or a production decline.

4) Improvement of the product quality by
Improvement of the water-holding properties (reduction of drip loss) by protecting the cell membranes
Improvement of the meat colour by delaying the pigment oxidation from the red oxymyoglobin to the brown metmyoglobin
Improvement of the stability of the fatty acids, and thereby the shelf life of the meat, by delaying lipid oxidation through the product's antioxidative activity of the product improvement of meat quality by lowering the risk of developing pale, soft and exudative (PSE) meat by stress reduction.

The inventive additive can with great benefit be used for monogastric animals, ruminants, fish, crustaceans, and pets.

### BEST MODE(S) FOR CARRYING OUT THE INVENTION

Formulation of Commercial Products with the Additive According to the Invention

Depending on the concentration and variety of the active substances in the raw material it can be desirable to mix the raw material with an appropriate carrier, vehicle and/or diluent, to provide a final product which is reasonably standardized and in a convenient technical form. For compounders and home mixers who mix the additive directly in animal feed the additive should not be too concentrated. Similar considerations apply when the additive is used by producers of preserved food products, feed products, cosmetics, pharmaceutics and other oxidation sensitive products for human or animal use.

To obtain the mentioned characteristics of a commercial feed additive, suitable carrier substances are primarily mineral carrier substances such as clay minerals and zeolites—sepiolite and clinoptiolite—and secondly vegetable carrier substances such as wheat flour, wheat bran, soy shell flour etc. Calcium carbonate can also be a useful carrier substance not so much because of its technical characteristics but because of its low price. This is also the case for grape seed flour, which is a known carrier substance used frequently in animals' feed.

A combination of the active component with clay minerals also result in an optimal utilization of the active substances when used as an intestine-active additive, because of the slow release effect of clay minerals. A combination with clay minerals thus ensures that the active substances are released in the lower part of the intestine.

It is also possible to add a natural emulsifier to the additive. Preferably such emulsifier should be free of genetically modified organisms (GMO). Preferred natural emulsifiers can be derived from quillaja, yucca or quinoa.

To obtain the mentioned characteristics of a commercial preservative additive, suitable carrier substances or anti-caking agents are primarily mineral carrier substances such as silica, clay minerals and zeolites—sepiolite and clinoptiolite—and secondly vegetable carrier substances such as wheat flour, wheat bran, soy shell flour etc. As for the feed additive calcium carbonate and grape seed flour can also be useful carrier substances for the same reasons as mentioned above. A further useful technical adjuvant is maltodextrin.

In other formulations the product can consist of a liquid from olive, as well as spray dried powders, without the addition of carrying agents. Liquids as well as spray dried products can be given to the animals via drinking water, possibly with a natural emulsifier, or it can be mixed directly in the feed, possibly as a premix.

The product can contain up to 5 weight % of an in feed acceptable organic acid in relation to olive products, by-products and wine by-products measured as dry matter. The product can also contain up to 10 weight % for feed acceptable salt in relation to olive products and by-products measured as dry matter.

Olive leaves and the pomace from the olive oil production can to a larger or smaller extent be ground before it is mixed with the actual carrier substance.

The additive according to the invention has revealed a considerable effect on the livestock's health, production efficiency, among others directly on feed intake, daily weight gain and feed utilization. The reasons for the concerned effects are not fully clear as there can be more than the ones stated so far. The already confirmed reasons include the following:

According to the invention the additive
reduces the usage of other antioxidants such as vitamin E and selenium in production animals and pets
has antimicrobial and antiviral characteristics
improves the nitrogen utilization
improves the nutrient substance utilization generally

In addition the additive appears to have an effect as described:
Protection against degradation of oxidation sensitive products and products containing carotenoids for both the human sector and for animals by its antioxidative effect
Improvement of the product quality of meat and milk for instance
Improves the water-restraining skill (reduction of drip loss)
Improves the meat colour
Improves fatty acid stability by its antioxidative activity

The inventive antioxidative additive may be used by animal production including animal breeding and production of animal products such as meat, eggs and milk. Thus the additive is added to the conventional animal feed. Typically the quantity of the additive for 1000 kg feed contains 1-1000 g of the olive based component based on an extract and depending on the concentration of the active substances and measured as dry matter. Preferably the amount of the component is 1.5-500 g, more preferred 2-100 g for 1000 kg animal feed. Based on this information the skilled person will easily be able to calculate useful concentrations of the additive to be added to the drinking water of the animals.

When used as a preservative the antioxidant additive is added to the oxygen sensitive material or product to be preserved. Calculated as a dried extract of olive leaves using a mixture of ethanol and water (60:40 v/v) for the extraction the level is typically 1-5000 ppm, preferably 10-3000 ppm and more preferred 100-2000 ppm based on the material to be preserved.

As stated the above weight amounts refer to dried extracts. In case the plant material is used in another form, for example as ground leaves, the amount of the active component in question should be one giving a similar amount of the antioxidative substances.

### EXAMPLES

In the present examples the following olive products are used:

Olive product A: Dried, ground olive leaves.
Olive product B: Dried ethanol/aqueous (60/40; v/v) extract of olive leaves.

The amount of additives in proportion of the feed amount is determined on the basis of dry feed with normal water content.

For the purpose of verifying the effect of the additive a number of trials have been held on Danish farms. Representative trial results can be seen in Examples 1 and 2. The use of an extract of olive leaves as a natural alternative to synthetic antioxidants is exemplified in Example 3.

### Example 1

Trial on “Bondeseje”, 21 day trial in the period 6-27 October, 2005. Piglets from weaning at an age of 28 days; 40 pigs in both the control and the trial group.

Tested additive: Nor-Guard O Powder, in the dosage 2 kg pr. ton of feed, consisting of 400 grams of Olive product A plus 800 grams Sepiolite 100 and 800 grams of wheat flour.

Results:

| | Control group | Trial group | Diff. % |
|---|---|---|---|
| No. of pigs | 40 | 40 | ±0.0% |
| Av. weight, start, kg | 6.73 | 6.68 | −7.4% |
| Av. weight, end, kg | 10.80 | 11.40 | +5.6% |
| Weight gain/pig/day, grams | 194 | 225 | +16.0% |
| Feed consumption/pig/day, kg | 0.31 | 0.37 | +19.4% |
| Feed/kg weight gain, kg | 1.61 | 1.64 | +1.9% |
| Mortality, No. of pigs | 0 | 0 | — |

The results indicate an increased daily weight gain of 16 percent, an increased daily feed intake of 19.4 percent, and an improvement in feed conversion of 1.9 percent.

### Example 2

Trial on “Svenstrup”, 7 day trial in the period 24-31 October, 2005. Piglets from weaning at an age of 28 days; 45 pigs in both the control and trial group.

Tested additive: Nor-Guard O, in a dosage of 2 kg pr. ton of feed, consisting of 15 grams Olive product B plus Sepiolit 100 and wheat flour as carrying agent.

### Results:

| | Control group | Trial group | Diff. % |
|---|---|---|---|
| No. of pigs | 45 | 45 | ±0.0% |
| Av. weight, start, kg | 5.59 | 5.58 | −0.32% |
| Av. weight, end, kg | | | |
| Weight gain/pig/day, grams | 135 | 150 | +11.4% |
| Feed consumption/pig/day, kg | 0.23 | 0.25 | +9.6% |
| Feed/kg weight gain, kg | 1.69 | 1.66 | −1.7% |
| Mortality, No. of pigs | 1 | 1 | — |

The results show an increased daily weight gain of 11.4 percent, an increased daily feed intake of 9.6 percent, and an improved feed conversion of 1.7 percent.

### Example 3

1000 g fish oil for usage in feed or food products is preserved by the addition of 1 g of Olive product B corresponding to 1000 ppm dried extract in the fish oil. In this way the additive substitutes synthetic antioxidants which may be carcinogenic.

The above description of the invention reveals that it is obvious that it can be varied in many ways. Such variations are not to be considered a deviation from the scope of the invention, and all such modifications which are obvious to persons skilled in the art are also to be considered comprised by the scope of the succeeding claims.

1. Natural or natural identical weight gain and feed conversion improving antioxidative additive which further to optional conventional carriers, adjuvants and/or additives as an active antioxidative principle includes an active component containing active substances derived from plant material from olive (Olea europaea L), wherein the active component is derived from olive leaves which leaves optionally has been subjected to drying, grinding and/or extraction.

2. (canceled)

3. (canceled)

4. Additive according to claim 1, wherein it further contains up to 5 weight % of organic acid acceptable for use in products used in the animal and/or human sector in relation to the active component derived from olive leaves, calculated as the dry matter of a dried extract.

5. Additive according to claim 1, wherein it further contains up to 10 weight % of salt acceptable for use in products used in the animal and/or human sector in relation to the active component derived from olive leaves, calculated as the dry matter of a dried extract.

6. Additive according to claim 1, wherein it includes a carrier material acceptable for use in food, feed or other products for human or animal use.

7. A natural weight gain and feed conversion improving antioxidative additive according to claim 1 for utilization as additive in animal feed, which additive further to optional conventional carriers, adjuvants and/or additives comprises a natural and/or nature identical active antioxidative principle including an active component containing active substances derived from leaves of olive (Olea europaea L.) which leaves optionally has been subjected to drying, grinding and/or extraction.

8. Additive according to claim 7, whereby in a quantity of additive calculated to 1000 kg of the total amount of feed given to the animals, it contains 1-5000 g of the active component derived from olive leaves calculated as the dry matter of a dried extract.

9. (canceled)

10. (canceled)

11. (canceled)

12. (canceled)

13. A method by producing livestock, wherein the animals are fed a feed mixture including a natural or natural identical weight gain and feed conversion improving antioxidative additive which further to optional conventional carriers adjuvants and/or additives as an active antioxidative principle includes an active component containing active substances derived from plant material from olive (Olea europaea L.), which active component is derived from olive leaves, which leaves optionally has been subjected to drying, grinding and/or extraction.

14. (canceled)

15. (canceled)

16. A method as claimed in 13, wherein the quantity of additive calculated to 1000 kg of the total amount of feed given to the animals, contains 1-5000 g of the active component derived from the olive leaves, calculated as the dry matter of a dried extract.

17. Use of a natural or natural identical weight gain and feed conversion improving antioxidative additive which further to optional conventional carriers, adjuvants and/or additives as an active antioxidative principle includes an active component containing active substances derived from leaves of olive (Olea europeae L.), which leaves optionally has been subjected to drying, grinding and/or extraction, as an additive in the animal feed by the production of livestock.
